(19) United States
(12) Patent Application Publication
(10) Pub. No.: US 2011/0285674 A1
(43) Pub. Date: Nov. 24, 2011

(54) CONTROL APPARATUS AND METHOD FOR LIQUID CRYSTAL DISPLAY

(75) Inventors: Tsung-Hsien TSAI, Taichung County (TW); Shu-Wei CHANG, Hsinchu City (TW)

(73) Assignee: NOVATEK MICROELECTRONICS CORP., Hsinchu (TW)

(21) Appl. No.: 13/035,226

(22) Filed: Feb. 25, 2011

(30) Foreign Application Priority Data
May 19, 2010 (TW) 99116002

(51) Int. Cl. G09G 5/00

(52) U.S. Cl. 345/204

(57) ABSTRACT

A control apparatus and method for a liquid crystal display are provided. The method includes the following steps. An input pixel datum of N bits is converted into a first pixel datum and the M most significant bits of the first pixel datum are outputted as a second pixel datum, wherein N and M are positive integers with N>M. FRC processing is performed with respect to the second pixel datum with one of a first frame cycle number and a second frame cycle number selectively according to the first pixel datum to output corresponding FRC pixel data, wherein the second frame cycle number is greater than the first frame cycle number.

This application claims the benefit of Taiwan application Serial No. 99116002, filed May 19, 2010, the subject matter of which is incorporated herein by reference.

### BACKGROUND OF THE INVENTION

1. Field of the Invention

The invention relates in general to a control apparatus and method for a liquid crystal display, and more particularly to a control apparatus for a liquid crystal display for increasing color levels and a method thereof.

2. Description of the Related Art

A video signal received by a flat display is denoted by RGB data during processing, wherein each of the three primary colors RGB is normally represented by a datum of 8 bits (or more bits such as 10 bits). Thus, the liquid crystal display requires a data driving circuit for processing 8-bit data for generating an analog signal to drive the panel.

Frame rate control (FRC) is a technology generally adopted for reducing circuit complexity of a liquid crystal display. FRC technology employs the data of a smaller number of bits to simulate the output effect (which can be measured by the number of colors) which can only be achieved by data of a larger number of bits. Thus, the display can adopt the driving circuit of a smaller number of bits to reduce hardware costs.

For example, FRC can be employed to process an M-bit (e.g., 6-bit) datum to produce the visual effect similar to that of N-bit (e.g., 8-bit) gray level, wherein controlling on and off patterns of a pixel for every X=2^{N-M}=4 frames is required to simulate 3 (=2^{N-M}−1) color levels between two adjacent M-bit color levels for the pixel, wherein N and M are positive integers N>M.

As M=6, FRC can at most produce 253 gray levels for a primary color, and the number of RGB colors that can be produced equals 253³□1.620 millions. In contrast, an 8-bit datum has 256 gray levels, and each pixel can produce 256³□1.677 million colors. Thus, when FRC is used to simulate 8-bit gray level effect with 6-bit data, about 0.6 million colors cannot be represented.

### SUMMARY OF THE INVENTION

The invention is directed to a control apparatus and a method for liquid crystal display. With frame rate control (FRC) being employed with different frame cycle numbers selectively, the gray levels that cannot be achieved by FRC with smaller frame cycle numbers can now be achieved by FRC with larger frame cycle numbers. Thus, the embodiments of the invention can simulate the same number of gray levels with the original pixel data. Therefore, the number of colors that can only be achieved by data driving circuitry for a larger number of bits can be achieved by a display with data driving circuitry for a smaller number of bits, hence reducing both hardware complexity and costs.

According to an aspect of the present invention, a control apparatus for liquid crystal display is provided. The control apparatus includes a conversion module and a frame rate control (FRC) unit. The conversion module is used for converting an inputted N-bit pixel datum into a first pixel datum and outputting the M most significant bits of the first pixel datum as a second pixel datum. The FRC unit performs FRC with respect to the second pixel datum selectively with one of a first frame cycle number and a second frame cycle number according to the first pixel datum so as to output corresponding FRC pixel data, wherein the second frame cycle number is greater than the first frame cycle number.

According to another aspect of the present invention, a control apparatus and method for liquid crystal display are provided. The control method includes the following steps. An inputted N-bit pixel datum is converted into a first pixel datum, and the M most significant bits of the first pixel datum are outputted as a second pixel datum, wherein N and M are positive integers with N>M. Frame rate control (FRC) processing is performed with respect to the second pixel datum selectively with one of a first frame cycle number and a second frame cycle number according to the first pixel datum to output corresponding FRC pixel data, wherein the second frame cycle number is greater than the first frame cycle number.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart of a control method for liquid crystal display according to a first embodiment.

FIG. 2 shows a relationship between transmittance and gray values that can be achieved by performing 6-bit FRC with respect to an inputted 8-bit pixel data.

FIG. 3 shows a relationship between 8-bit gray values and the gray values represented by a first pixel datum.

FIGS. 4A-4B are examples of 8 cyclic base patterns.

FIG. 5 shows a comparison between the 8-bit pixel data values and their corresponding luminance, between gray values of the first pixel datum and their corresponding luminance, and between 6-bit FRC gray values and their corresponding luminance.

FIG. 6 shows a block diagram of a control apparatus for a liquid crystal display according to a second embodiment.

FIGS. 7 and 8 show block diagrams of other examples of a control apparatus for a liquid crystal display.

### DETAILED DESCRIPTION

The invention relates to a control apparatus and a method for a liquid crystal display. In an embodiment, by employing the frame rate control (FRC) method with different frame cycle numbers selectively, the gray levels that cannot be achieved by FRC with smaller frame cycle numbers are achieved by FRC with larger frame cycle numbers. Thus, the present embodiment of the invention can simulate the same number of gray levels that can be achieved by the original pixel data of original number of bits. Thus, the display can adopt a data driving circuit of smaller number of bits, which reduces circuit complexity, achieves the richness of colors, and reduces hardware costs.

### First Embodiment

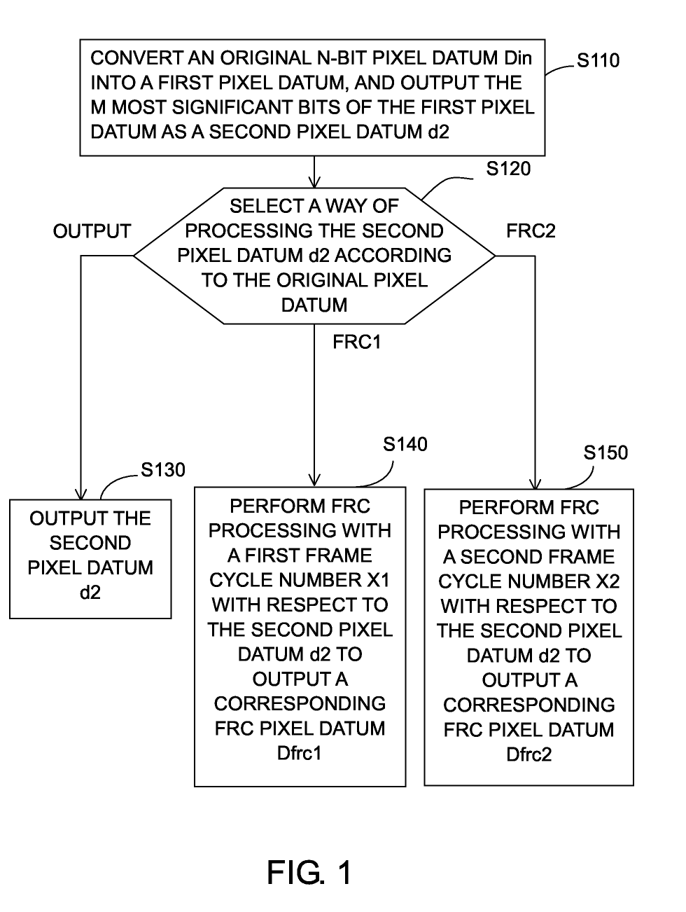

Referring to FIG. 1, a flowchart of a control method for liquid crystal display according to a first embodiment is shown. As indicated in step S110, an original N-bit pixel datum Din is converted into a first pixel datum, and the M most significant bits of the first pixel datum are outputted as a second pixel datum d2. As indicated in step S120, a way of processing the second pixel datum d2 is selected according to the original pixel datum. As indicated in step S130, if the second pixel datum d2 does not need FRC processing according to the original pixel datum, then the second pixel datum d2 is outputted. In step S140, FRC processing with a first frame cycle number X1 is performed with respect to the second pixel datum d2 according to the original pixel datum so as to output a corresponding FRC pixel datum Dfrc1. In step S150, FRC processing with a second frame cycle number X2 is performed with respect to the second pixel datum d2 according to the original pixel datum to output a corresponding FRC pixel datum Dfrc2. The second frame cycle number X2 is greater than the first frame cycle number X1.

How the above method increasing the number of gray levels (that is, the number of color levels) simulated by M-bit (e.g., 6-bit) FRC processing to be the same as that achieved by N-bit (e.g., 8-bit) pixel data is exemplified below.

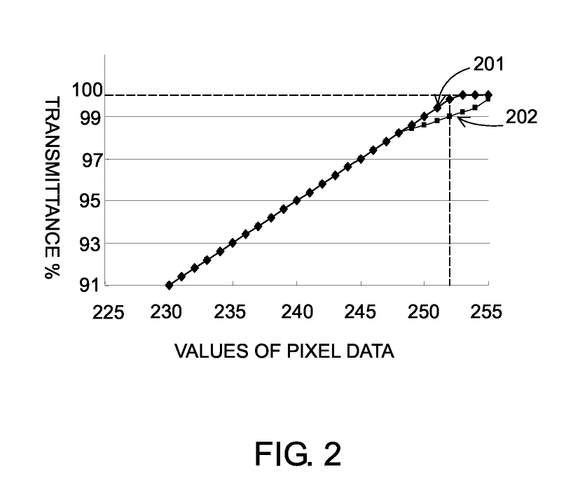

When 6-bit FRC processing is performed with respect to an 8-bit pixel datum, at most 253 gray values can be represented. The curve 201 of FIG. 2 shows a correspondence relationship between transmittance (or luminance) and the values of the inputted 8-bit pixel datum. When the value of the inputted 8-bit pixel datum is greater than 252, the corresponding transmittance is already saturated (100%), so that color richness is reduced. Given that the Gamma curve is equal to 1.0, suppose the maximum transmittance is 100%, for the 6-bit FRC, the transmittance per gray level is (100%)/253□0.4%. For the 256 gray values to correspond to different transmittance levels, the 8-bit gray values 252-255 must correspond to different transmittance levels. In other words, the transmittance corresponding to each interval of some or all of the adjacent gray values must be smaller than a transmittance of 0.4%.

Let the curve 202 of FIG. 2 be taken for example. The curve 202 overlaps the curve 201 when the value of the inputted pixel datum is smaller than 249, but the transmittance corresponding to each interval between the adjacent integral gray values is smaller than the transmittance of 0.4% when the value of the inputted pixel datum ranges between 249 to 255. Thus, some gray values (e.g., including decimal portions) within the range (that is, 250 to 255) that cannot be simulated by 6-bit FRC with 4-frame cycle can be simulated by 6-bit FRC with a larger frame cycle number (e.g., 8-frame cycle). Accordingly, in step S120, when it is known that the first pixel datum corresponds to these gray levels that cannot be simulated by 6-bit FRC with 4-frame cycle, the second pixel datum d2 is selectively processed by 6-bit FRC with a larger frame cycle e.g., 8-frame cycle (as indicated in step S150). In this way, the correspondence relationship between transmittance and an original 8-bit pixel datum as indicated by the curve 202 of FIG. 2 can be realized. In other words, the present embodiment employs 6-bit FRC to enable the same number of gray levels (that is 256) that an 8-bit pixel datum can represent.

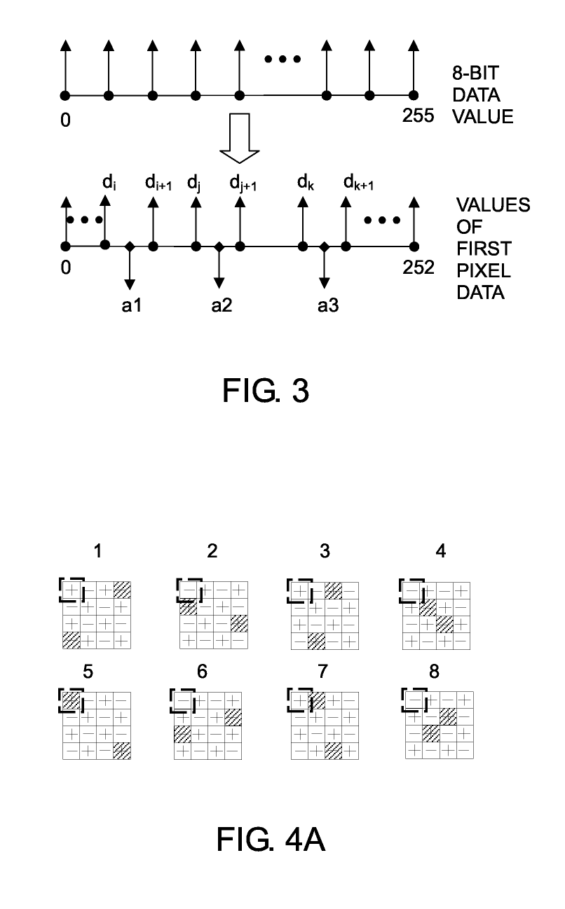

In addition to the correspondence relationship illustrated in the curve 202 of FIG. 2, the present embodiment can be used in other correspondence relationships. FIG. 3 shows a correspondence relationship between 8-bit gray values and their corresponding 6-bit FRC gray values (that is, the gray values represented by the first pixel datum as indicated in step S110), wherein the upward arrows denote integral gray values. The number of gray values of an 8-bit pixel datum that 6-bit FRC can present equals:

GN(N,M)=2^{N}−2^{N-M}+1=253, wherein N=8, M=6;

In other words, there are still 3 (=2^{N-M}−1) 8-bit gray values that cannot be one-to-one corresponded to the integral gray values for 6-bit FRC. Under such circumstance, a new gray value can be inserted between two integral gray values for 6-bit FRC, according to the present embodiment. For example, a1 is inserted between dᵢ and dᵢ₊₁, a2 is inserted between dᵢ and dⱼ₊₁, and a3 is inserted between dₖ and dₖ₊₁, wherein i, j and k are integers, dᵢ, dⱼ and dₖ indicate three integral gray values for 6-bit FRC, and a1 to a3 are denoted by downward arrows. Thus, a one-to-one correspondence relationship is established between the 8-bit gray values and the integral gray values for 6-bit FRC plus three inserted values a1 to a3. In this way, FIG. 3 indicates that the corresponding gray values for 6-bit FRC (denoted by upward arrows) can be processed in step S140, and the values a1 to a3 (denoted by downward arrows) can be processed in step S150. Moreover, the values of a1 to a3 can be set arbitrarily, depending on the needs of the design. For example, the values of a1 to a3 may be set as decimal numbers such as 0.5, 0.25, or 0.75, and may be inserted among three corresponding integral gray values for 6-bit FRC. In other embodiments, three or more gray values may be set with a decimal portion.

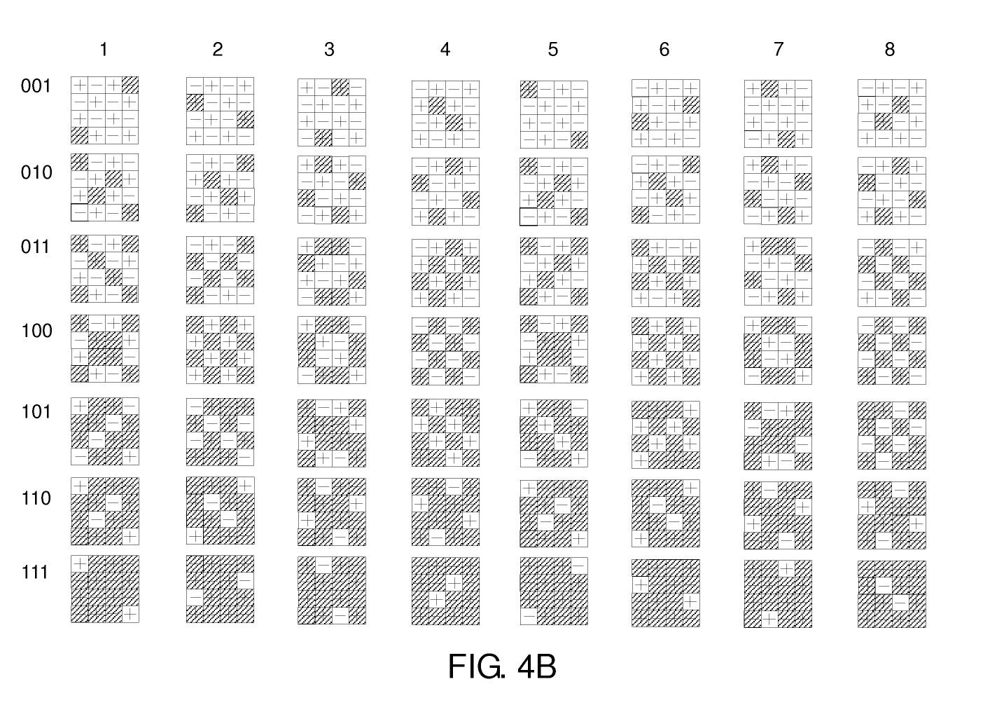

Simulating the number of 8-bit gray levels by using 6-bit FRC is exemplified below. In this example, when the two least significant bits (LSB) of the inputted pixel datum are 01 (denoted by LSB=01), the luminance is defined by brightness level 1 (about 0.4% transmittance). When LSB=10, the luminance is brightness level 2; when LSB=11, the luminance is brightness level 3. When the gray values are non-integral, such as the values between 249 and 255 of FIG. 2 or the values of a1 to a3 of FIG. 3, the way of achieving the corresponding luminance is disclosed below. For example, as it is desired to achieve a gray value of 244.5 given that the LSB for 244 is 00 and the LSB for 245 is 01, FRC processing originally performed with the number of frame cycle number X1 is now changed to be processed with the number of frame cycle number X2, wherein X1=2^{(N-M)}=4, X2=2^{(N-M+1)}=8. FIG. 4A illustrates 8 cyclic base patterns for achieving the gray value of 244.5, for example. In FIG. 4A, each base pattern includes 16 grids, each grid denotes one sub-pixel, a non-slashed grid denotes an integral gray value d, and a slashed grid denotes the gray value of the sub-pixel being d+1. Further, the positive signs (+) and the negative signs (−) in the grids denote polarity conversion of a liquid crystal display. However, the present embodiment is not limited to the above exemplification, and one of ordinary skill in this art can apply different polarity conversion, and the similarities are not repeated for the sake of brevity. As indicated in FIG. 4A, the gray value of the sub-pixel defined by the first data line and the first scan line (that is, the top-left grid of each base pattern that is marked by bold dashed lines) equals d+1 every 8 frames and, in average, virtually contributes 0.5 gray level (relative increment in transmittance is: 0.5*0.4%=0.2%). In the same manner, in order to produce a gray level of 245.5, there should be 3 occurrences of a gray value of d+1 on each sub-pixel every 8 frames in average.

Besides, FIG. 4B illustrates other examples of 8 groups of cyclic base patterns. When a gray value with decimal portion is inserted between the integral gray values that 6-bit FRC can represent for an 8-bit pixel datum, an indication bit can be employed to indicate whether the gray value has a decimal portion. For example, Base[0]=1 indicates that there is a decimal portion 0.5, and Base[0]=0 indicates that there is no decimal portion. In FIG. 4B, each value of the first column on the left side corresponds to 8 cyclic base patterns arranged in a row, wherein the values denote the two least significant bits of the gray values for 6-bit FRC (that is, Base[2:1]) plus an additional bit Base[0]. For example, to simulate a gray value of 244.5, given that Base[2:1]=00 and Base[0]=1, the 8 cyclic base patterns corresponding to 001 can be used for performing step S150 for the 6-bit second pixel datum d2 (that is, Base[8:3] of 244: 111101₂). To simulate the gray value of 245, given that Base[2:0]=010, the 8 cyclic base patterns corresponding to 010 can be used for conversion. Since 245 is an integer, step S140 is performed with a 4-frame cycle, in the 2^{nd} row, the first to the fourth base patterns are a repetition of the fifth to the eighth base patterns. The correspondence relationships between other gray values such as 245.5, 246, 246.5, 247.5 and their base patterns can be obtained in the same manner, and the repetitions are not repeated here.

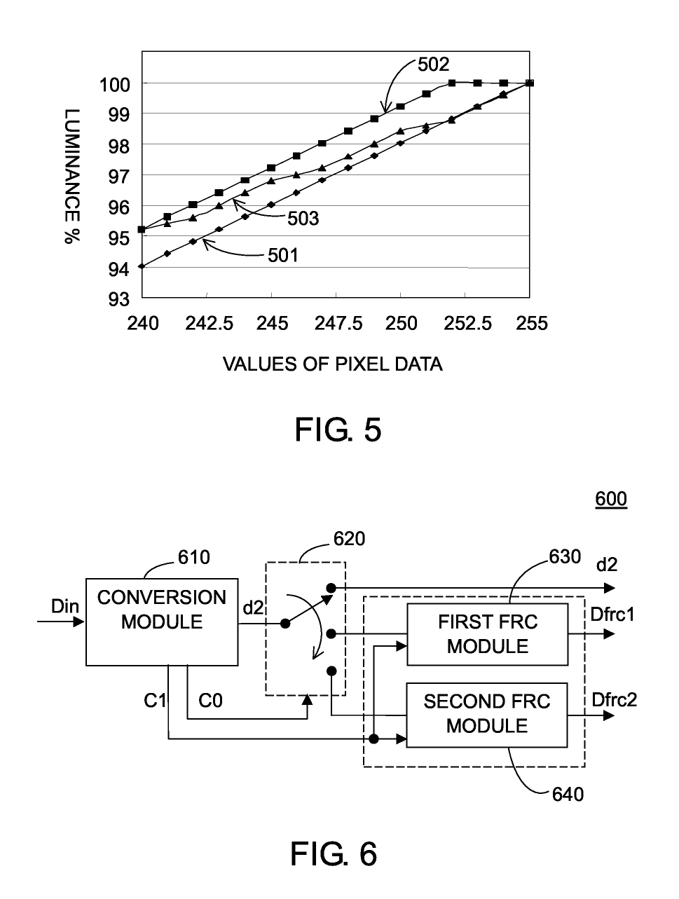

In an embodiment, steps S140 and S150 can be performed with fewer base patterns by adding new gray values with appropriate values for implementing step S110. For example, a number of gray values of the first pixel datum, such as 240, 244, 248, with the two least significant bits Base[2:1]=00 (i.e., the two least significant bits of the integer portion), corresponding to the two least significant bits (that is, N−M=2) of the original pixel datum, are selected and the gray values with decimal portions are designed to appear after the gray values with Base[2:1]=00. Referring to FIG. 3, in the above example, dᵢ=240, dⱼ=244, dₖ=248, a1=240.5, a2=244.5, a3=248.5, so that the base patterns required by the gray values with decimal portions only appear when Base[2:0]=001. Thus, the present embodiment can do without the base patterns corresponding to Base[2:0]=011, Base[2:0]=101 and Base[2:0]=111 of FIG. 4B, and the hardware complexity can be further reduced when the present embodiment is implemented by hardware. According to the present embodiment, the relationship between the 8-bit pixel data values and their corresponding luminance (%), the relationship between the 6-bit FRC gray values and their corresponding luminance (%) and the relationship between the gray values of the first pixel datum and their corresponding luminance (%) are illustrated in Table 1. In addition, according to Table 1, in FIG. 5, the curve 501 denotes the corresponding luminance (%) of the 8-bit pixel datum, the curve 502 denotes the corresponding luminance (%) of the 6-bit FRC gray values, and the curve 503 denotes the corresponding luminance (%) of the gray values of the first pixel datum. As indicated in Table 1 and FIG. 5, there is a one-to-one correspondence relationship between the 8-bit pixel data values and the gray values of the first pixel datum of the present embodiment, and both the data values and the gray values can provide 256 different gray levels. By using the above embodiment in the presentation of the RGB primary colors, 6-bit FRC can present as many colors as the 8-bit color levels, that is, 256³□1.677 million colors.

TABLE 1

| | | | | | Corres- |
|---|---|---|---|---|---|
| | Corres- | | Corres- | Gray | ponding |
| | ponding | | ponding | values | luminance |
| 8-bit | luminance | | luminance | of the | % of the |
| pixel | % of the | Gray | % of the | first | gray values |
| data | 8-bit pixel | values for | 6-bit FRC | pixel | of the first |
| values | data values | 6-bit FRC | gray values | datum | pixel datum |
| 0 | 0 | 0 | 0 | 0 | 0 |
| 1 | 0.4 | 1 | 0.4 | 1 | 0.4 |
| 2 | 0.8 | 2 | 0.8 | 2 | 0.8 |
| . . . | . . . | . . . | . . . | . . . | . . . |
| 240 | 94 | 240 | 95.2 | 240 | 95.2 |
| 241 | 94.4 | 241 | 95.6 | 240.5 | 95.4 |
| 242 | 94.8 | 242 | 96 | 241 | 95.6 |
| 243 | 95.2 | 243 | 96.4 | 242 | 96 |
| 244 | 95.6 | 244 | 96.8 | 243 | 96.4 |
| 245 | 96 | 245 | 97.2 | 244 | 96.8 |
| 246 | 96.4 | 246 | 97.6 | 244.5 | 97 |
| 247 | 96.8 | 247 | 98 | 245 | 97.2 |
| 248 | 97.2 | 248 | 98.4 | 246 | 97.6 |
| 249 | 97.6 | 249 | 98.8 | 247 | 98 |
| 250 | 98 | 250 | 99.2 | 248 | 98.4 |
| 251 | 98.4 | 251 | 99.6 | 248.5 | 98.6 |
| 252 | 98.8 | 252 | 100 | 249 | 98.8 |
| 253 | 99.2 | 252 | 100 | 250 | 99.2 |
| 254 | 99.6 | 252 | 100 | 251 | 99.6 |
| 255 | 100 | 252 | 100 | 252 | 100 |

As illustrated in the above embodiment, by assigning all of the new gray levels with decimal portions to be after Base[2:1]=00 or 01 or 10 or 11, both the number of base patterns and the hardware complexity can be effectively reduced. Let the gray values with decimal portions be assigned to be after Base[2:1]=00 be taken for example. As indicated in Table 1 and FIG. 5, only four base patterns, namely, Base[2:0]=001, 010, 100, 110, are required. In comparison to the FIG. 4B which requires 7 base patterns, the complexity is reduced by 42.8%.

### Second Embodiment

FIG. 6 shows a block diagram of a control apparatus for a liquid crystal display according to a second embodiment. The control apparatus of FIG. 6 can be used for implementing the control method of the first embodiment. As indicated in FIG. 6, the control apparatus 600 includes a conversion module 610, a switching device 620, a first frame rate control (FRC) module 630 and a second FRC module 640. The conversion module 610 convert an N-bit original pixel datum Din into a first pixel datum and further outputs the M most significant bits of the first pixel datum as a second pixel datum d2 so as to implement step S110. According to the original pixel datum, e.g., a control signal C0 generated from the original pixel datum, the switching device 620 selectively transmits the M-bit second pixel datum d2 to the first FRC module 630 or to the second FRC module 640 or outputs the M-bit second pixel datum d2 so as to implement step S120. According to the original pixel datum, e.g., a control signal C1 generated from the original pixel datum, the first FRC module 630 performs FRC processing with a first frame cycle number X1 with respect to the second pixel datum d2 to output a corresponding FRC pixel datum Dfrc1, so as to implement step S140. According to the original pixel datum, e.g., the control signal C1, the second FRC module 640 performs FRC processing with a second frame cycle number X2 with respect to the second pixel datum d2 to output a corresponding FRC pixel datum Dfrc2, so as to implement step S150. The second frame cycle number X2 is greater than the first frame cycle number X1.

The conversion module 610, e.g., according to FIG. 2, 3 or 5 and the correspondence relationship illustrated in Table 1, converts the original N-bit pixel datum Din into the first pixel datum and outputs the M most significant bits as the second pixel datum d2. Let Table 1 be taken for example. When the original pixel datum Din ranges between 0 to 239, the first pixel datum of the conversion module 610 has the same value as the original pixel datum Din, and the six most significant bits of the original pixel datum Din can be directly outputted as the second pixel datum d2. When the original pixel datum Din ranges between 240 to 255, the conversion module 610 generates a first pixel datum according to the correspondence relationship of Table 1 and outputs the six most significant bits of the first pixel datum as the second pixel datum d2. The two least significant bits of the first pixel datum plus the bit denoting decimal number (that is, Base[2:0]) can be outputted and used as a control signal C1. For example, when Base[2:0]=000, i.e., the first pixel datum being an integral multiple of X1, or the remainder of the first pixel datum divided by X1 being equal to 0, the conversion module 610 can output a control signal C0 (e.g., 00) to control the switching device 620 and output the second pixel datum d2 to a driving circuit of the display panel. When Base[0]=1, the conversion module 610 can output a control signal C0 (e.g., 10) to control the switching device 620 so as to output the second pixel datum d2 to the second FRC module 640 for further processing. When Base[0]=0 and Base[2:1]≠00, the conversion module 610 can output a control signal C0 (e.g., 01) to control the switching device 620 so as to output the second pixel datum d2 to the first FRC module 630 for further processing.

In the above example of the control apparatus 600 based on Table 1, when the value of the control signal C0 equals 01 or 10, the second pixel datum d2 is outputted to the first FRC module 630 or the second FRC module 640 for further processing. According to the control signal C1, the first FRC module 630 selects one of the 3 groups of base patterns of FIG. 4B satisfying Base[2:0]=010, 100, or 110 and uses only a half of the frames of the selected group of base patterns, that is, 4 frames (because of the repetition of patterns). For example, the second FRC module 640, according to the control signal C1, selects the group of base patterns satisfying Base[2:0]=001. Thus, the value of the control signal C1 is exemplified to be the same as Base[2:0]. In another example, the first FRC module 630 can select suitable base patterns satisfying Base[2:1] according to the control signal C1. In addition, the above base patterns can be stored in a memory either inside or outside the first FRC module 630 or the second FRC module 640.

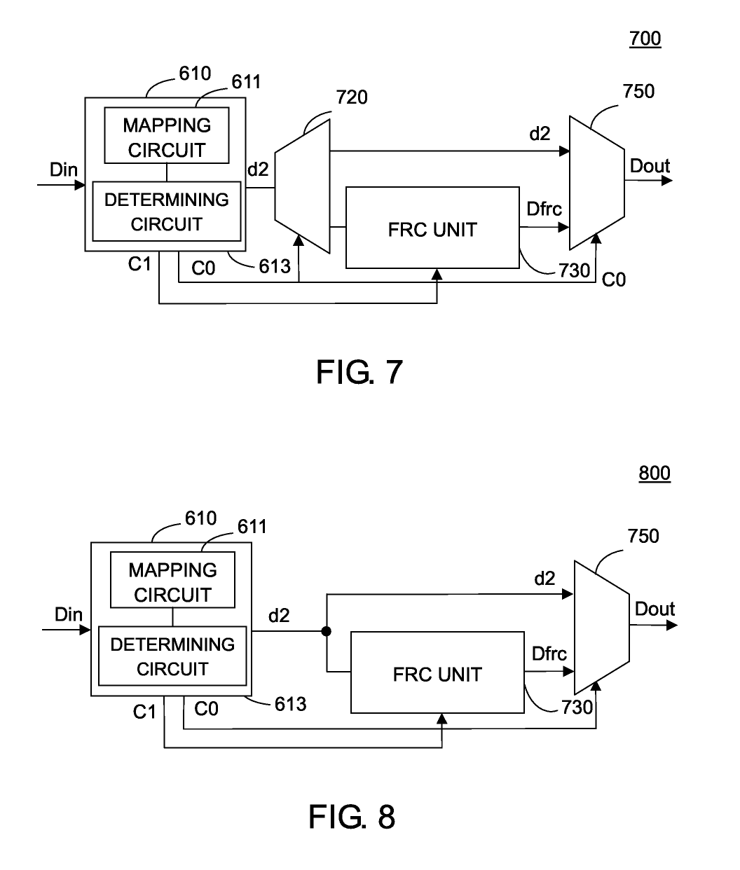

Referring to FIG. 7, another example of a control apparatus for a liquid crystal display is shown. The control apparatus 700 of FIG. 7 is different from the control apparatus 600 of FIG. 6 in that an FRC unit 730 replaces the first FRC module 630 and the second FRC module 640 to simplify the design. The FRC unit 730, according to the control signal C1, selects one of the four groups of base patterns satisfying Base[2:0]=001, 010, 100, or 110 to output a corresponding FRC pixel datum Dfrc. In FIG. 7, the switching device 620 of FIG. 6 is realized by a de-multiplexer 720. When Base[2:0]=000, the de-multiplexer 720, according to the control signal C0 (e.g., 0), outputs the second pixel datum d2 to drive the display panel. When Base[2:0] is not equal to 000, the de-multiplexer 720, according to the control signal C0 (e.g., 1), outputs the second pixel datum d2 to the FRC unit 730. The FRC unit 730, according to the control signal C1, performs FRC processing with one of the frame cycle number X1 and the frame cycle number X2 selectively for the data (i.e., d2) received from one of the output ports of the de-multiplexer 720 to output a corresponding FRC pixel datum (FRC data), wherein X2>X1, X1=2^{N-M}, X2=2^{N-M+1}. The FRC unit 730, for example, includes a first FRC module 630 and a second FRC module 640. The FRC unit 730, which can also be realized as a unit including a memory for storing the required base patterns and a corresponding digital circuit, outputs the base patterns according to the frame switching rate of FRC processing with the selected frame cycle number. Likewise, the first FRC module 630 and the second FRC module 640 can also be realized in the same manner. In an embodiment of practical application, the FRC pixel datum outputted from the FRC unit 730 is based on different frame cycle numbers selectively, but the frame rate of the display itself does not need to be changed.

In another example, a switching output device, e.g., a multiplexer 750, can be added to receive the second pixel datum d2 outputted from the de-multiplexer 720 or the pixel datum Dfrc outputted from the FRC unit 730, and accordingly output a signal Dout to an M-bit data driving circuit for example. Likewise, a suitable switching device or multiplexer can be added to the control apparatus 600 of FIG. 6 to output the result to the data driving circuit of a liquid crystal display.

In the control apparatuses 600 and 700, the design of the conversion module 610 can be adapted for a correspondence relationship between the inputted pixel datum and the first pixel datum, and, for example, can be realized by a logic circuit or a digital circuit. As illustrated in FIG. 7, the conversion module 610 may include a mapping circuit 611 and a determining circuit 613. The mapping circuit 611 is used for converting the inputted pixel datum Din into a first pixel datum according to a correspondence relationship illustrated in Table 1, wherein the six most significant bits Din[8:3] of the inputted pixel datum Din and the two least significant bits Din[2:1] are separately processed according to the correspondence relationship illustrated in Table 1. The determining circuit 613 is used for outputting control signals C0 and C1 according to the first pixel datum.

Referring to FIG. 8, yet another example of a control apparatus for a liquid crystal display is shown. The control apparatus 800 of FIG. 8 is different from the control apparatus 700 of FIG. 7 in that the conversion device 610 outputs the second pixel datum d2 to an input port of the multiplexer 750 and the FRC unit 730. In other examples, the control apparatus 600 of FIG. 6 can be realized in a manner similar to the control apparatus 800 of FIG. 8. In addition, the input/output of the control apparatuses 600, 700 and 800 can be arranged in series or in parallel.

The principles of the above embodiments can further be used in other examples of simulating an N-bit (e.g., 10-bit) pixel datum with M-bit (e.g., 8-bit) FRC, and the number of gray levels can be achieved by the M-bit FRC processing is the same as that of the N-bit pixel datum, wherein N>M. In the above embodiments, the other gray levels are obtained from the simulation of FRC plus spatial base patterns. However, the size and arrangement of the above base patterns are for exemplification only, and one who is skilled in the art can employ base patterns of other size or different patterns, or merely perform FRC processing with respect to only one single pixel (that is, the size of the base pattern is 1×1).

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A control apparatus for liquid crystal display, comprising:
a conversion module for converting an inputted N-bit pixel datum into a first pixel datum and outputting the M most significant bits of the first pixel datum as a second pixel datum, wherein N and M are positive integers with N>M; and
a frame rate control (FRC) unit for performing FRC processing with respect to the second pixel datum with one of a first frame cycle number and a second frame cycle number selectively according to the first pixel datum to output FRC pixel data, wherein the second frame cycle number is greater than the first frame cycle number.

2. The control apparatus according to claim 1, wherein a one-to-one correspondence relationship exists between the first pixel datum and the inputted pixel datum, and:
the conversion module controls the FRC unit to perform FRC processing with respect to the second pixel datum with the first frame cycle number when the first pixel datum corresponds to one of a plurality of gray values of a first portion of 2^{N} gray values;
the conversion module controls the FRC unit to perform FRC processing with respect to the second pixel datum with the second frame cycle number when the first pixel datum corresponds to one of a plurality of gray values of a second portion of 2^{N} gray values.

3. The control apparatus according to claim 2, wherein the N−M least significant bits of the N most significant bits corresponding to the second portion of gray values have a same value equal to one of 0 to 2^{N-M}−1.

4. The control apparatus according to claim 2, wherein N−M is equals to 2, the N−M least significant bits of the N most significant bits corresponding to the second portion of gray values have a same value of one of 00, 01, 10 and 11.

5. The control apparatus according to claim 1, wherein the conversion module further outputs a first control signal and a second control signal, which are based on the first pixel datum;
the control apparatus further comprises:
a switching device having a plurality of output ports, wherein the switching device receives the second pixel datum and selectively outputs the received second pixel datum through one of these output ports according to the first control signal;
the FRC unit for performing FRC processing with respect to the second pixel datum received from the switching device with one of the first frame cycle number and the second frame cycle number selectively according to the second control signal to output corresponding FRC pixel data.

6. The control apparatus according to claim 5, wherein the FRC unit comprises:
a first FRC module for selectively performing FRC processing with respect to the second pixel datum with the first frame cycle number to output corresponding FRC pixel data;
a second FRC module for selectively performing FRC processing with respect to the second pixel datum with the second frame cycle number to output corresponding FRC pixel data.

7. The control apparatus according to claim 5, further comprising:
a switching output device for selectively outputting one of the second pixel datum and the FRC pixel datum according to the first pixel datum.

8. The control apparatus according to claim 1, wherein the FRC unit comprises:
a first FRC module for selectively performing FRC processing with respect to the second pixel datum with the first frame cycle number to output corresponding FRC pixel data;
a second FRC module for selectively performing FRC processing with respect to the second pixel datum with the second frame cycle number to output corresponding FRC pixel data.

9. The control apparatus according to claim 1, further comprising:
a switching output device for selectively outputting one of the second pixel datum and the FRC pixel datum according to the first pixel datum.

10. A control method for a liquid crystal display, comprising:
converting an inputted N-bit pixel datum into a first pixel datum and outputting the M most significant bits of the first pixel datum as a second pixel datum, wherein N and M are positive integers with N>M; and
performing FRC processing with respect to the second pixel datum with one of a first frame cycle number and a second frame cycle number selectively according to the first pixel datum to output FRC pixel data for driving a liquid crystal display, wherein the second frame cycle number is greater than the first frame cycle number.

11. The control method according to claim 10, wherein there is a one-to-one correspondence relationship between the first pixel datum and the inputted pixel datum, and the step of performing FRC processing with respect to the second pixel datum comprises:
performing FRC processing with respect to the second pixel datum with the first frame cycle number when the first pixel datum corresponds to one of a plurality of gray values of a first portion of 2^{N} gray values;
performing FRC processing with respect to the second pixel datum with the second frame cycle number when the first pixel datum corresponds to one of a plurality of gray values of a second portion of 2^{N} gray values.

12. The control method according to claim 11, wherein the N−M least significant bits of the N most significant bits corresponding to the second portion of the gray values have a same value equal to one of 0 to 2^{N-M}1.

13. The control method according to claim 12, further comprising: outputting the second pixel datum to drive the liquid crystal display when the first pixel datum corresponds to one of a plurality of gray values of a third portion of 2^{N} gray values.

14. The control method according to claim 11, wherein N−M is equals to 2, the N−M least significant bits of the N most significant bits corresponding to the second portion of the gray values have a same value equal to either of 00, 01, 10 and 11.

15. The control method according to claim 11, further comprising: outputting the second pixel datum to drive the liquid crystal display when the first pixel datum corresponds to one of a plurality of gray values of a third portion of 2^{N} gray values.
